(19) United States
(12) Patent Application Publication
(10) Pub. No.: US 2014/0076026 A1
(43) Pub. Date: Mar. 20, 2014

(54) RELATIVE HUMIDITY SENSOR

(71) Applicant: THERM-O-DISC, INCORPORATED, Mansfield, OH (US)

(72) Inventors: Jared Starling, Mansfield, OH (US); Philip S. Young, Hayesville, OH (US); Gary D. Dinges, Mansfield, OH (US)

(73) Assignee: THERM-O-DISC, INCORPORATED, Mansfield, OH (US)

(21) Appl. No.: 13/623,408

(22) Filed: Sep. 20, 2012

(51) Int. Cl. G01N 27/00

(52) U.S. Cl. CPC G01N 27/00
USPC 73/29.02

(57) ABSTRACT

The present disclosure provides a relative humidity sensor including a sensor electronics assembly that is encased in a body assembly that protects the sensor electronics assembly. A humidity sensor element, though, remains exposed to the ambient environment through an aperture in the body assembly. One or more filter(s) comprising a porous membrane can cover the aperture at different locations within the humidity sensor. The filter can be attached during the construction of the body assembly thereby simplifying the manufacture of the humidity sensor.

### FIELD

The present disclosure relates to humidity sensors, and particularly to a relative humidity sensor construction having improved response time characteristics.

### BACKGROUND

This section provides background information related to the present disclosure which is not necessarily prior art.

Humidity sensors of the type that detect the relative humidity of air by absorbing water from the ambient environment into a humidity sensor element and detecting a change in the dielectric constant or conductivity of the humidity sensor element as a function of the relative humidity are known.

Relative humidity sensors (RHS) are, therefore, often implemented in environments where there is a likelihood of water vapor, condensation, moisture and/or particulate materials. As a result, some humidity sensors are designed to include protective encapsulation and/or a porous membrane over the sensor electronics that allows water vapor to pass through to a humidity sensor element, but not liquid water. In these cases, the space or volume contained between the membrane and the humidity sensor element is referred to as the “dead space.” It can be desirable to minimize the volume of the “dead space,” particularly as it relates to the area of the membrane, to minimize the sensor response time characteristics. Also, reducing the dead space reduces the amount of water vapor that can condense in this space, improving the recovery time of the sensor after condensation.

### SUMMARY

This section provides a general summary of the disclosure, and is not a comprehensive disclosure of its full scope or all of its features.

The present disclosure provides a relative humidity sensor. In one aspect of the disclosure, the humidity sensor includes a sensor electronics assembly that is encased in a body assembly that protects the sensor electronics assembly. A humidity sensor element, though, remains exposed to the ambient environment through an aperture in the body assembly. One or more filter(s) comprising a porous membrane can cover the aperture at different locations within the humidity sensor, to substantially eliminate the “dead-space” volume, producing optimum response characteristics from the sensor. The filter can be attached during the construction of the body assembly thereby simplifying the manufacture of the humidity sensor.

In another aspect of the disclosure, a humidity sensor includes a body having an aperture. An electronics assembly including a sensor element is located in the body, though the sensor element remains exposed to the ambient environment through the aperture in the body. A first filter located directly adjacent to the sensor element is included and covers the aperture. In addition, a second filter is included that is located on an exterior surface of the body and also covers the aperture.

In another aspect of the disclosure, a humidity sensor includes a body having an aperture. A first molded sub-assembly at least partially encapsulates an electronics assembly and a filter, and also includes a sensor element. The filter is disposed directly adjacent to the sensor element. The first molded sub-assembly is fixed within the body such that the filter and sensor element are aligned with the aperture in the body and are exposed to the ambient environment of the humidity sensor through the aperture in the body.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a top perspective view of a humidity sensor according to the present disclosure;

FIG. 1B is a bottom perspective view of the humidity sensor of FIG. 1A;

FIG. 2 is a top perspective view of a sensor electronics assembly of the humidity sensor of FIG. 1A;

FIG. 3 is a top perspective view of a sensor electronics over-mold sub-assembly of the humidity sensor of FIG. 1A;

FIG. 4A is a top perspective view of a sensor body housing of the humidity sensor of FIG. 1A;

FIG. 4B is a bottom perspective view of the sensor body housing of FIG. 4A;

FIG. 5A is a cross-sectional front view of the humidity sensor of FIG. 1A according to one embodiment of the present disclosure;

FIG. 5B is a cross-sectional front view of the humidity sensor of FIG. 1A according to an alternative embodiment of the present disclosure;

FIG. 5C is a cross-sectional front view of the humidity sensor according to another alternative embodiment of the present disclosure;

FIG. 6 is a top perspective view of another humidity sensor according to the present disclosure;

FIG. 7 is a bottom perspective view of the humidity sensor of FIG. 6;

FIG. 8A is plan view of the humidity sensor of FIG. 6;

FIG. 8B is a right side view of the humidity sensor of FIG. 8A;

FIG. 8C is a left side view of the humidity sensor of FIG. 8A;

FIG. 9 is a perspective view of an exemplary housing for the humidity sensor of FIG. 6;

FIG. 10 is a top perspective view of still another humidity sensor according to the present disclosure;

FIG. 11 is a rear perspective view of the humidity sensor of FIG. 10;

FIG. 12A is plan view of the humidity sensor of FIG. 10;

FIG. 12B is a right side view of the humidity sensor of FIG. 12A;

FIG. 12C is a left side view of the humidity sensor of FIG. 12A;

FIG. 13 is a perspective view of an exemplary housing for the humidity sensor of FIG. 10; and

FIG. 14 is a graph showing the performance response of the humidity sensor according to present disclosure.

Corresponding reference numerals indicate corresponding parts throughout the several views of the drawings.

### DETAILED DESCRIPTION

Example embodiments will now be described more fully with reference to the accompanying drawings.

The present disclosure provides a relative humidity sensor including a sensor electronics assembly that is encased in a body assembly that protects the sensor electronics assembly. A humidity sensor element, though, remains exposed to the ambient environment through an aperture in the body assembly. A filter comprising a porous membrane can cover the aperture. The filter can be attached during the construction of the body assembly thereby simplifying the manufacture of the humidity sensor.

The present disclosure provides alternative constructions of the humidity sensor that can vary the location of the filter and/or the filter parameters (e.g., pore size) and/or the number of filters to affect the response characteristics of the humidity sensor. For example, the filter can be spaced apart a short distance from the sensor element or it can be located directly adjacent to the sensor element. It is, therefore, possible to control and/or substantially reduce or eliminate the “dead space” volume of the humidity sensor, improving the humidity sensor's reliability and/or enabling the response characteristics of the humidity sensor to be optimized for particular applications or environments.

Referring now to the figures, the humidity sensor 10 of the present disclosure comprises a sensor electronics assembly 12 including a humidity sensor element 14 that is encased in a body assembly 16 in a two-part molding process. A first molding operation encapsulates the sensor electronics assembly 12 in a protective plastic material to create a sensor electronics over-mold sub-assembly 18. A second molding operation secures the sensor electronics over-mold sub-assembly 18 within a housing 20 of the body assembly 16. An aperture 22 in a wall 24 of the housing 20 provides an opening between the ambient environment to the sensor element 14. One or more filter(s) 26 comprising a porous membrane is situated to cover the aperture 22 and may be located adjacent to the sensor element 14. The atmosphere of the ambient environment can penetrate filter(s) 26 so that the sensor element 14 can be exposed to the atmosphere, while at the same time liquid water, condensation, and/or particulate matter can be prohibited from passing through the filter 26.

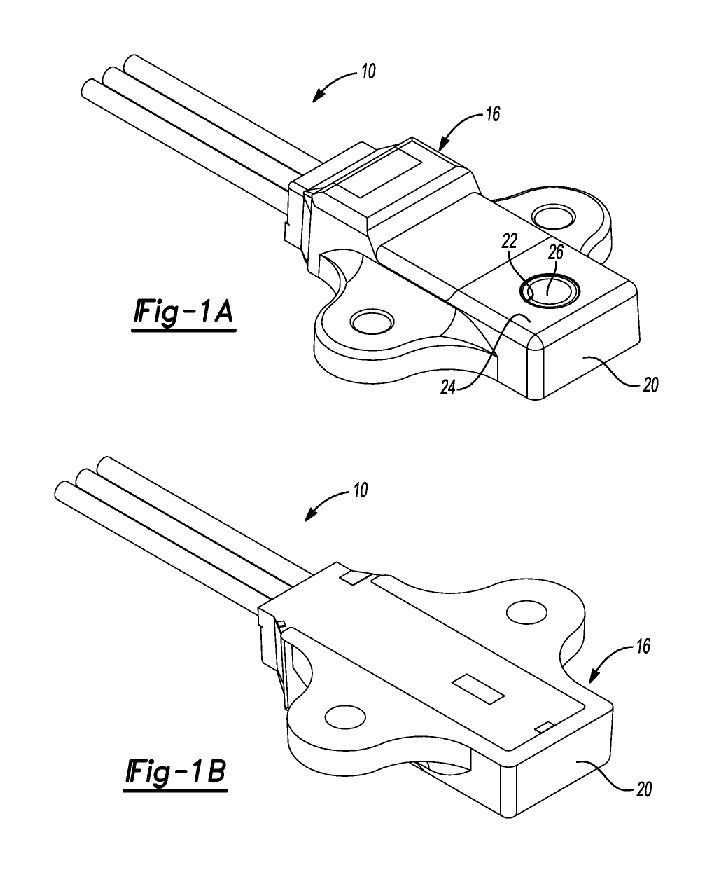

FIGS. 1A and 1B show a top perspective view and a bottom perspective view, respectively, of a humidity sensor 10 constructed according to the present disclosure.

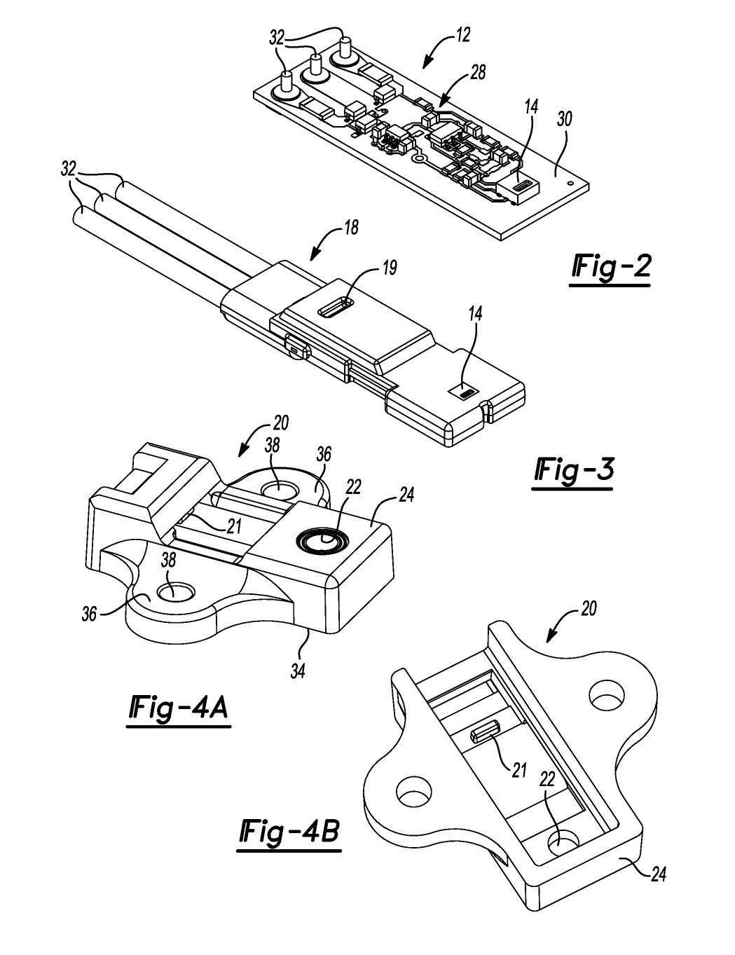

The sensor electronics assembly 12 of the humidity sensor 10 of the present disclosure is illustrated in FIG. 2. The sensor electronics assembly 12 comprises a humidity sensor element 14 and a sensor circuit 28 disposed on a printed circuit board substrate 30. The sensor circuit 28 includes a plurality of leads 32 (e.g., Vin, Vout, Gnd). The humidity sensor element 14 can comprise a capacitive-type humidity sensor packaged in a single-chip integrated circuit. A known sensor that is suitable for use in the humidity sensor 10 of the present disclosure is available from Sensirion Inc. (www.sensirion.com) under the part no. SHT21P.

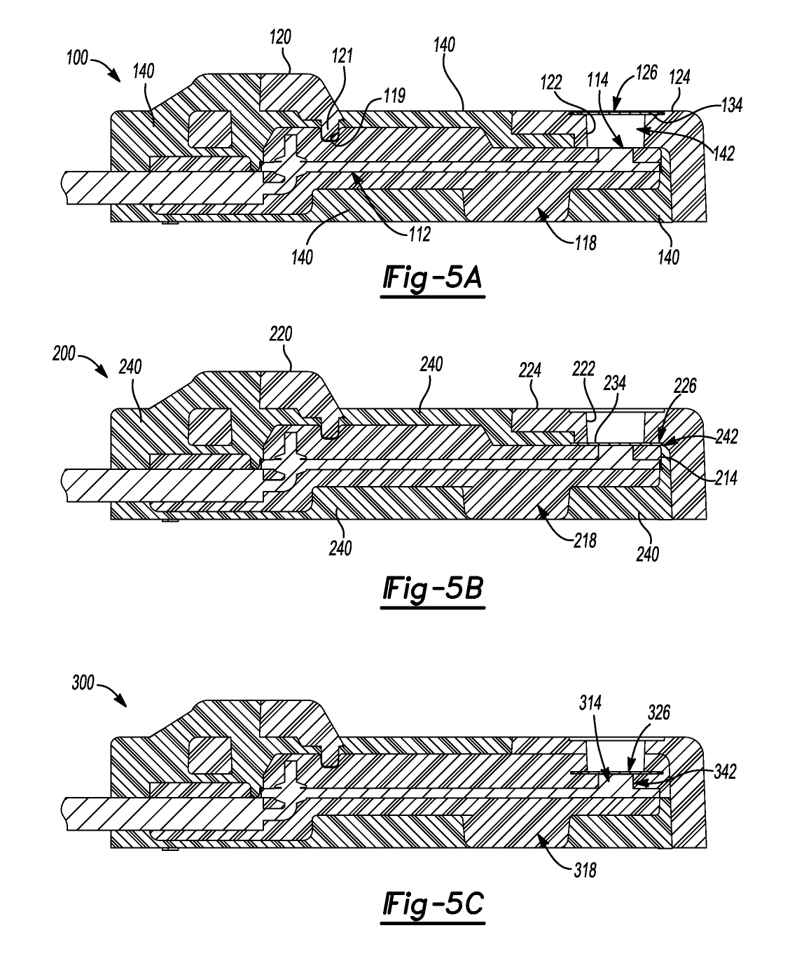

FIG. 3 shows a top perspective view of the sensor electronics assembly 12 subsequent to the first molding operation where it can be formed into the sensor electronics over-mold sub-assembly 18. In the first molding operation, the sensor circuit 28 and the ends of the leads 32 of the sensor electronics assembly 12 can be completely encapsulated by a plastic material. However, the sensor element 14, itself, is only partially covered by plastic, as shown in FIGS. 3, and 5A-5C. In this regard, the plastic molding material abuts and/or adheres to the lateral sides of the sensor element 14; however, an upper side of the sensor element (i.e., the side opposite to the PCB substrate) is not covered by the plastic during the first molding operation and remains exposed to the environment. Also provided in the exterior surface of sensor electronics over-mold sub-assembly 18 by the first molding operation is a locating detent 19. As further discussed below, the locating detent 19 enables the sensor electronics over-mold sub-assembly 18 to be positioned within the housing 20 so that the sensor element is aligned with the aperture 22 prior to the second molding operation. A mold cavity (not shown) for the first molding operation can form the exterior surface of the sensor electronics over-mold sub-assembly 18 while masking the sensor element 14 from the molding plastic. A suitable plastic material for encapsulating the sensor electronics assembly 12 includes polyamide.

Referring to FIGS. 4A and 4B, the housing 20 of the sensor body assembly 16 is shown. The housing 20 comprises an outer shell and forms an exterior surface of the humidity sensor 10. The housing 20 includes an aperture 22 through an upper wall 24 which, when the humidity sensor 10 is assembled, is aligned with the exposed sensor element 14 of the sensor electronics over-mold sub-assembly 18. As discussed below, one or more filters 26 comprising a porous membrane can be situated to cover the aperture 22. An optional counter bore 34 or other locating feature can be included in the exterior surface of the wall 24 of the housing 20 for receiving and/or positioning the filter 26 over the aperture 22. The housing 20 can also include one or more mounting flanges 36. Each mounting flange 36 comprises an attachment portion 38 that is operable to accommodate a fastener or other attachment device to facilitate positioning or fixing the humidity sensor 10 at a location in an environment where the humidity is to be sensed. The housing 20 can be formed from a suitable plastic material, such as by molding.

As best seen in FIG. 4B, the housing 20 of the sensor body assembly 16 also comprises an interior space bounded by an interior surface which can serve as a portion of a mold cavity for a second molding operation for constructing the humidity sensor 10 of the disclosure. Prior to the second molding operation, the sensor electronics over-mold sub-assembly 18 can be positioned within the interior space of the housing 20. In this regard, the housing 20 includes a locating projection 21 that can extend inwardly from the interior surface of housing 20. The locating projection 21 can be sized and shaped to be received within the locating detent 19 included in the exterior surface of the sensor electronics over-mold sub-assembly 18. When the two respective locating features are nested together, the sensor element 14 is in proper alignment with the aperture 22. Of course, the positioning features described above could be. One or more additional mold cavity(ies) (not shown) can close off a remainder of a mold volume into which a plastic molding material can be subsequently injected to fill the interior space of the housing 20. A suitable plastic material for the second molding operation includes polyamide. FIGS. 1A and 1B show the molded humidity sensor 10 after completion of the second molding operation.

Several exemplary and alternative constructions for the humidity sensor 10 of the disclosure are best seen in FIGS. 5A-5C. A first exemplary construction is shown in the cross-sectional front view of the humidity sensor 100 of FIG. 5A. As illustrated, the sensor electronics assembly 112 can be encapsulated by the molded plastic from the first molding operation to form the sensor electronics over-mold sub-assembly 118. The upper side of the sensor element 114 (e.g., the side opposite to the PCB substrate), however, can remain uncovered by plastic and can be exposed. The sensor electronics over-mold sub-assembly 118 can be positioned in the housing 120 by seating the locating projection 121 within the locating detent 119. As such, the exposed side of the sensor element 114 can be aligned with the aperture 122 in the upper wall 124 of the housing 120. The plastic 140 from the second molding operation can provide the remainder of the interior structure of the humidity sensor 100 and fix the sensor electronics over-mold sub-assembly 118 in place within the housing 120. The filter 126 can be attached at the exterior surface of the wall 124 of the housing 120 to cover the aperture 122. Alternatively, the filter 126 can be attached at a counter-bore 134 in the exterior surface of the wall 124 of the housing 120. The filter 126 can be attached to the housing 120 by an adhesive, ultrasonic welding, or other known methods.

A second exemplary construction for the humidity sensor 200 of the disclosure is shown in FIG. 5B. As shown, the filter 226 can be located directly adjacent to the sensor element 214. In this second construction, the filter 226 can be positioned at the interior surface of the housing 220 to cover the aperture 222 in the wall 224 of the housing 220 prior to the second molding operation. The sensor electronics over-mold sub-assembly 218 can then be positioned in the housing 220 such that the filter 226 lies over of the exposed side of the sensor element 214 when it is aligned with the aperture 222 in the upper wall 224 of the housing 220. After the second molding operation, the remainder of the interior structure comprises the molded plastic 240. The filter 226 can be attached to the interior surface of the housing 220 prior to installing the sensor electronics over-mold sub-assembly 218 by an adhesive, ultrasonic welding, or other known methods. Alternatively, the filter 226 can simply be mechanically sandwiched between the sensor electronics over-mold sub-assembly 218 and the interior surface of the housing 220; that is, without any additional attachment mechanism. A counter bore 234 or other locating feature can be included in the interior surface of the housing 220 for receiving and/or positioning the filter 226 over the aperture 222. After the second molding operation, then, both the filter 226 and sensor electronics over-mold sub-assembly 218 can be fixed in place in the housing 220.

Still another exemplary construction for the humidity sensor 300 of the disclosure is shown in FIG. 5C. As illustrated in FIG. 5C, the filter 326 can be included as part of the sensor electronics over-mold sub-assembly 318. In this construction, the filter 326 can be positioned over the upper side of the sensor element 314 prior to the first molding operation. In the first molding operation, the mold cavity (not shown) can enable the filter 314 to be held in position as plastic is molded around a peripheral edges of the sensor element 314 and filter 326. After the first molding operation, the filter 326 can become fixed in place over the sensor element 314 so as to be integral with the sensor electronics over-mold sub-assembly 318. The second molding operation can fix both the sensor electronics over-mold sub-assembly 318, including the filter 326, in place in the housing 320.

In addition, the humidity sensor according to the disclosure can comprise a construction including multiple filters and/or filter(s) having different porosity sizes (i.e., pore sizes). For example, combinations of the several humidity sensor constructions already described can be made such that two or three filters can be included, and the filters can have the same or different porosity. For example, with reference to FIG. 5C, an additional filter can alternatively be included at the exterior surface of the housing (as in FIG. 5A) and/or at the interface between the sensor electronics over-mold sub-assembly and the interior surface of the housing (as in FIG. 5B).

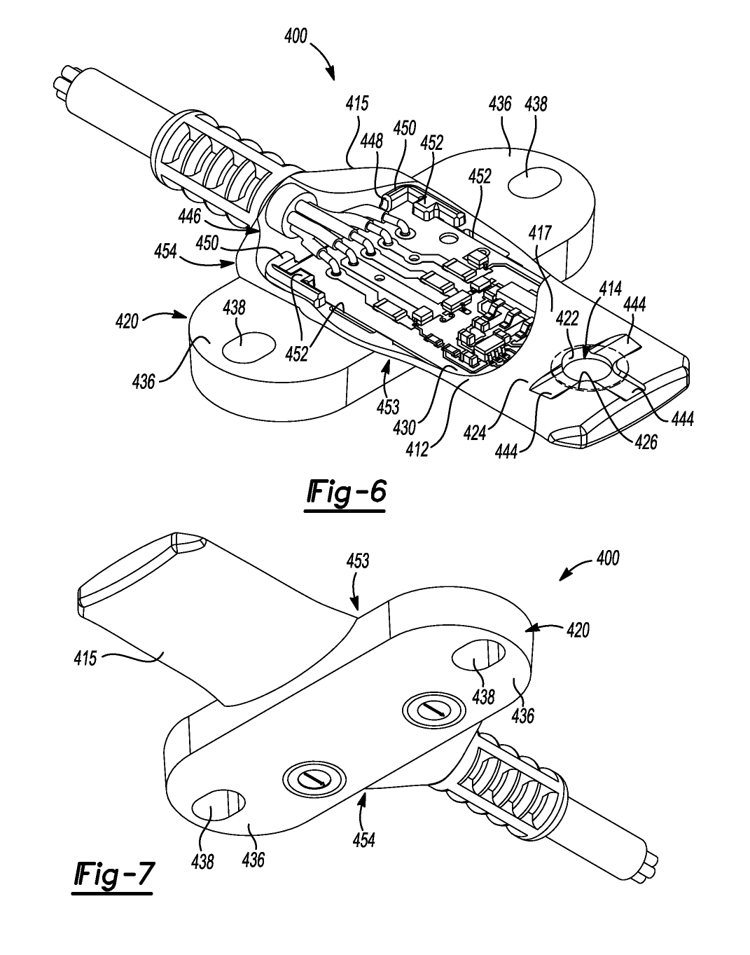

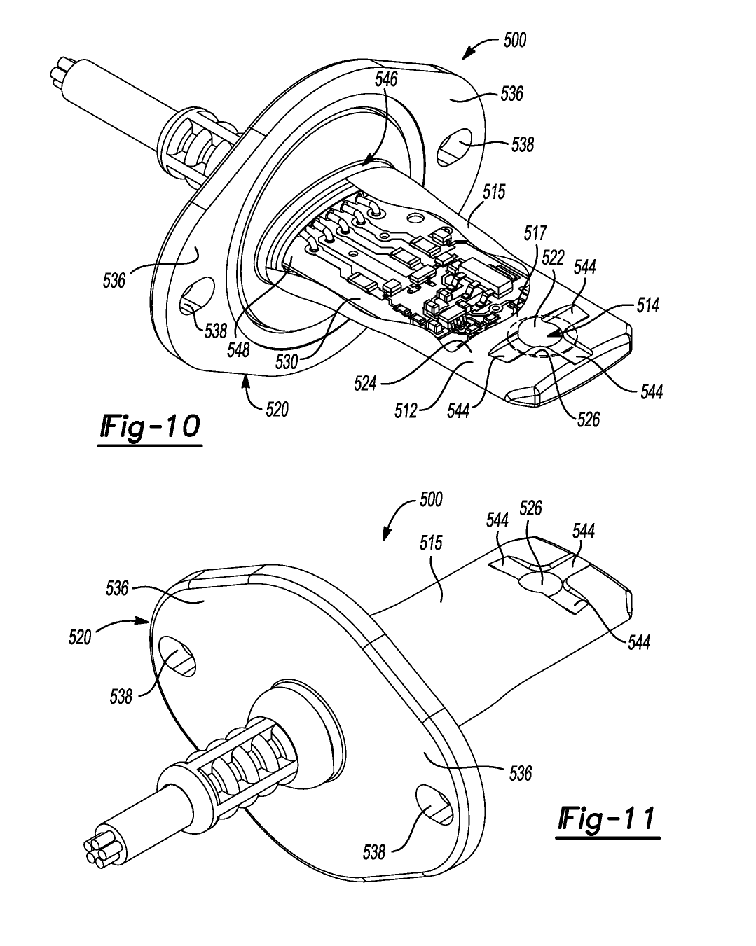

FIGS. 6 and 10 illustrate still additional exemplary humidity sensors constructed according to the teachings and principles of the present disclosure. Referring to FIGS. 6-9, a humidity sensor 400 of the disclosure is shown as comprising a sensor electronics assembly 412 as previously described, including a humidity sensor element 414, that is attached to a housing 420. The sensor electronics assembly 412 and housing 420 are then encased within a protective plastic body 415. In this respect, a single molding operation can create an over-molded plastic body 415 that both encapsulates the sensor electronics assembly 412 and secures the sensor electronics assembly 412 to the housing 420. An aperture 422 in a wall 424 of the over-molded body 415 provides an opening between the sensor element 414 and the ambient environment. A filter 426 comprising a porous membrane can be situated adjacent to the sensor element 414 and beneath the over-molded body 415. After the molding operation, the filter 426 can become fixed in place over the sensor element 414, in a manner similar to that which is shown in either of FIGS. 5B or 5C. Alternatively or in addition, a second filter can be included that covers the aperture 422 at the exterior surface 417 of the over-molded body 415, in a manner similar to that which is shown in FIG. 5A. The atmosphere of the ambient environment can penetrate the filter(s) 426 so that the sensor element 414 can be exposed to the atmosphere, while at the same time liquid water, condensation, and/or particulate matter can be prohibited from passing through the filter(s) 426.

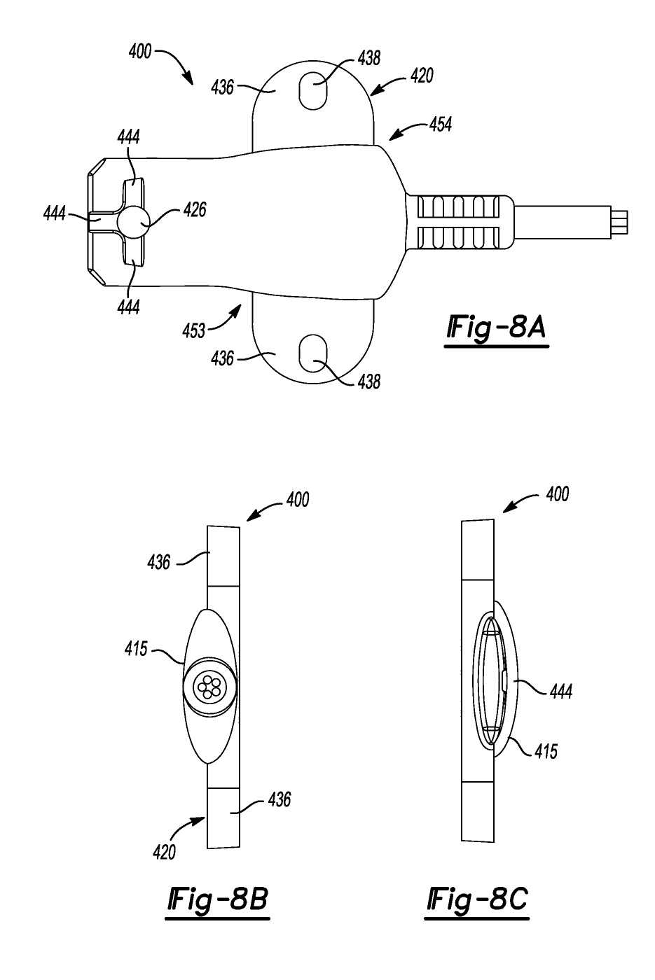

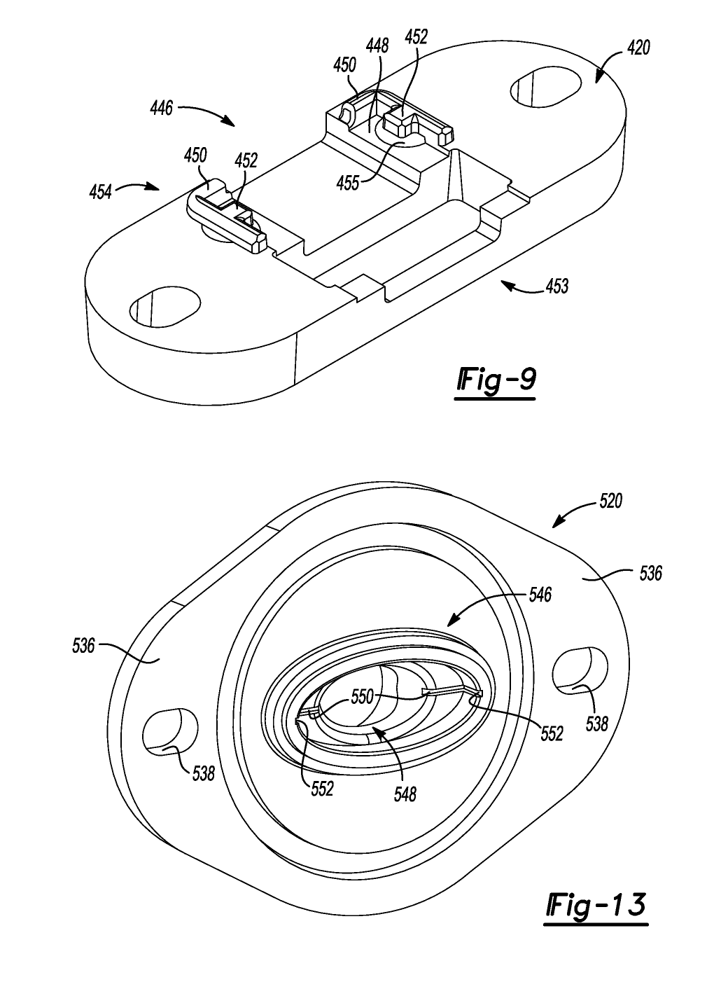

As a further feature, the humidity sensor 400 can include one or more channels 444 in the exterior surface 417 of the over-molded body 415 located at or near the aperture 422. As best seen in FIGS. 6 and 8A, the channel(s) 444 can be created in the exterior surface 417 of the body 415, either as part of the molding operation forming the over-molded body 415 or thereafter by removing material from the as-formed, over-molded body 415. The channels 444 can serve to inhibit the accumulation or collection of liquid water, condensation, and/or particulate matter at or near the aperture 422. In this regard, the channel(s) 444 can extend outwardly from the aperture 422 toward an outer edge of the body 415 to provide a pathway for any moisture or particulates to flow away from the aperture 422. The channel(s) 444 can also be angled or pitched in a direction away from the aperture 422 (e.g., toward an outer edge of the body 415) in order to enhance their ability to draw any moisture or particulates away from the aperture 422.

As described above, the humidity sensor 400 includes a housing 420 which is attached to the sensor electronics assembly 412 and secured thereto as a result of the molding process forming the over-molded body 415. The housing 420 is oriented generally parallel with the sensor electronics assembly 412 and comprises one or more mounting flanges 436. Each mounting flange 436 comprises an attachment portion 438 that is operable to accommodate a fastener or other attachment device to facilitate positioning or fixing the humidity sensor 400 at a location in an environment where the humidity is to be sensed. The housing 420 can be formed from a suitable plastic material.

With continued reference to FIG. 6 and further reference to FIG. 9, the housing 420 can also include a recess portion 446 in which the sensor electronics assembly 412 can be received, prior to the molding process forming the over-molded body 415. The recess portion 446 can include a base 448, one or more positioning tabs 450, and one or more retaining tabs 452. The base 448 comprises a generally flat surface on which the printed circuit board substrate 430 of the sensor electronics assembly 412 can be placed. Projecting generally inward from opposite sides of the recess portion 446 toward the center of the recess portion 446 are the one or more positioning tab(s) 450 and one or more retaining tab(s) 452. The positioning tab(s) 450 are located at a second end 454 of recess portion 446 and can serve to situate the printed circuit board substrate 430 of the sensor electronics assembly 412 relative to the housing 420 prior to the molding operation. The retaining tab(s) 452 are located at one or more places intermediate the first 453 end and second end 454 of the recess portion 446 and are spaced vertically away from the base 448 so as to create a gap 455 therebetween. The retaining tab(s) 452 can serve to hold the printed circuit board substrate 430 of the sensor electronics assembly 412 in place at its location in the housing 420 prior to the molding operation, such as by friction. As an example, the printed circuit board substrate 430 of the sensor electronics assembly 412 can be received in the recess portion 446 of the housing 420 from the first end 453. The printed circuit board substrate 430 can be slid into the gap(s) 455 between the retaining tab(s) 452 and the base 448 until it abuts against the positioning tab(s) 450 and can slide no further. The force of friction between the printed circuit board substrate 430 and the retaining tab(s) 452 and the base 448 can hold the printed circuit board in place. Of course, other means to hold the printed circuit board in place can also be employed, like a tab and corresponding slot, or pin and corresponding hole, or the like.

After the sensor electronics assembly 412 is situated relative to the housing 420, the molding operation can be performed to create the over-molded body 415 of the humidity sensor 400. A mold cavity (not shown) for the molding operation can form the exterior surface 417 of the body 415 while masking the sensor element 414 and filter 426 from the molding plastic to also create the aperture 422. As discussed above, the mold cavity can optionally create the channel(s) 444 in the exterior surface 417 of the body 415, as well. A suitable plastic material for the molding operation includes polyamide.

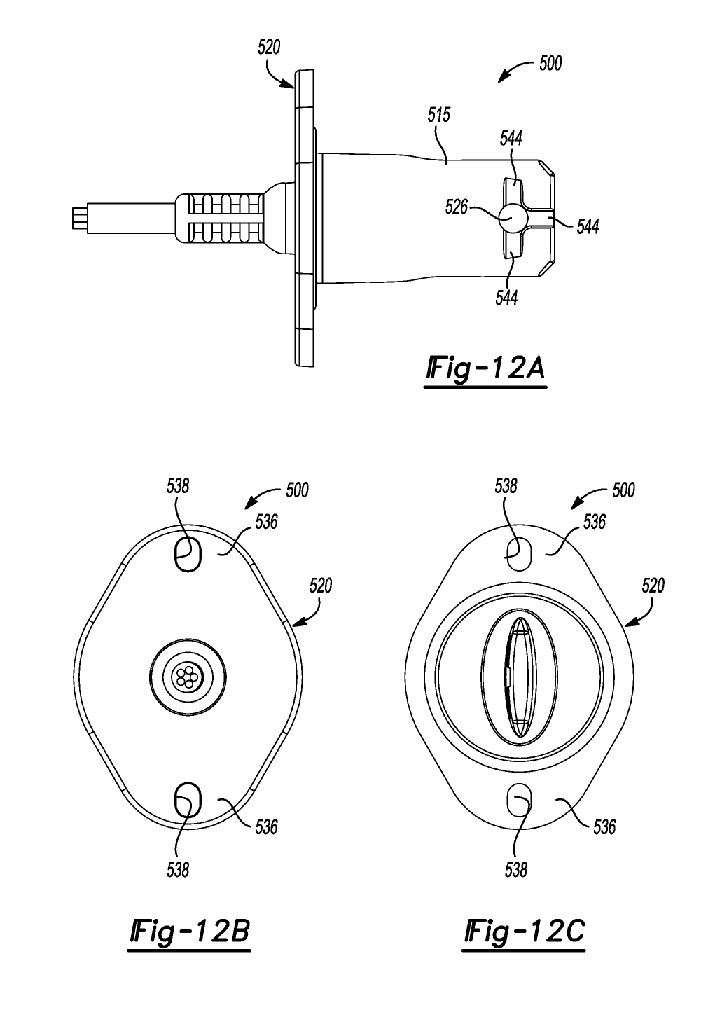

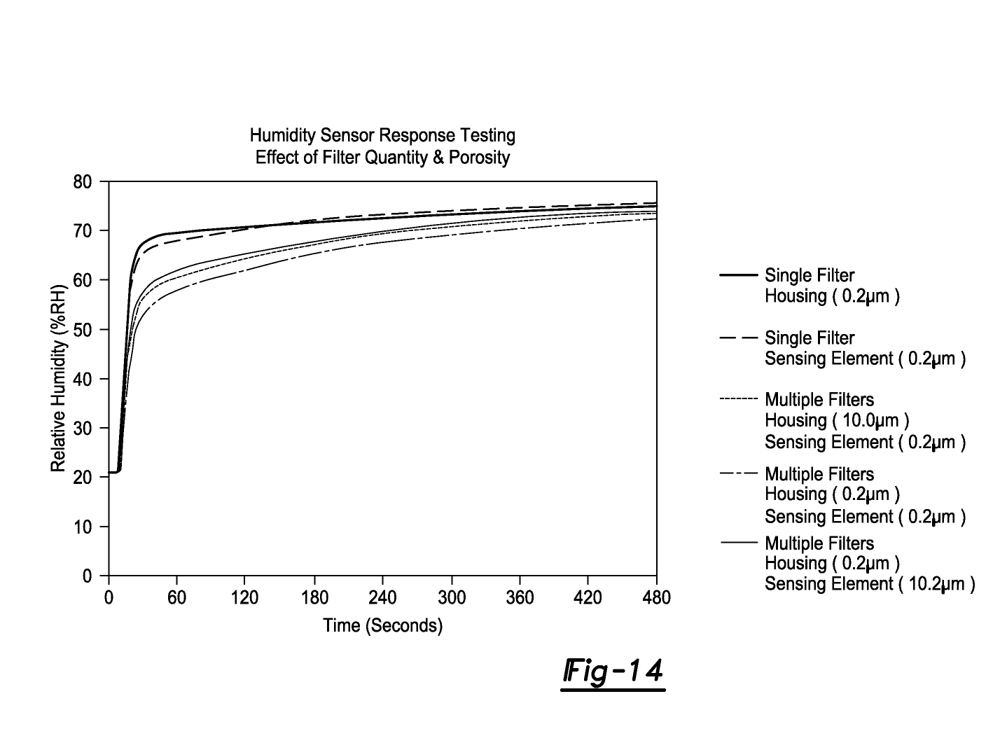

FIGS. 10, 11, 12A, 12B and 12C show another embodiment of a humidity sensor 500 according to the present disclosure. The humidity sensor 500 is constructed in a manner and has features similar to that described above with respect to humidity sensor 400, with corresponding reference numerals indicating corresponding parts. In the humidity sensor 500, a housing 520 is attached to the sensor electronics assembly 512 and secured thereto by the molding process forming the over-molded body 515. The housing 520 is oriented generally perpendicular to the sensor electronics assembly 512 and comprises one or more mounting flanges 536. Each mounting flange 536 comprises an attachment portion 538 that is operable to accommodate a fastener or other attachment device to facilitate positioning or fixing the humidity sensor 500 at a location in an environment where the humidity is to be sensed. The housing 520 can be formed from a suitable plastic material.

Referring now to FIG. 13, the housing 520 can also include a collar portion 546 in which the sensor electronics assembly 512 can be received, prior to the molding process forming the over-molded body 515. The collar portion 546 can comprise an opening 548 extending through the housing 520 and into which the sensor electronics assembly 512 can be located prior to the molding operation that forms the body 515. Similarly to that described above, positioning and/or retaining features such as slots 550, 552, for example, can be included in the housing 520 to locate and/or hold the sensor electronics assembly 512 in place in the housing 520 prior to the molding operation.

Attached at FIG. 14 is a graph depicting how filters at different locations in the humidity sensor, multiple filters, and/or filters having different pore sizes can impact the response time of a humidity sensor according to the disclosure at a given relative humidity. According to the graph of FIG. 8, the humidity sensor having the fastest response time for the humidity sensors tested included a single filter with a pore size of 0.2 μm attached at the exterior surface of the housing. Response time increased as the single filter of the same pore size (0.2 μm) was moved closer and/or adjacent to the sensor element. As can be understood from FIG. 8, for the humidity sensors including multiple filters (in this case two filters, one having a pore size of 10.0 μm and the other having a pore size of 0.2 μm), the response time continued to increase as a filter having a smaller pore size was located closer to the sensor element. The construction having the longest response time also had two filters with the smallest pore size (0.2 μm).

In some circumstances, longer response times may be desirable. For example, the longer response time can have the effect of dampening the response signal of the humidity sensor and/or minimizing the occurrence or impact of hysteresis of the output signal caused, e.g., by rapid changes in the humidity of the measured environment. Adjusting and/or manipulating the response characteristics of the humidity sensor may also be beneficial if the humidity sensor may be exposed to temperature changes, since the thermal response and humidity response characteristics of the sensor may vary.

As can be appreciated, the exemplary humidity sensor constructions 100, 200, 300, 400 and 500 of the present disclosure can provide a humidity sensor having minimal “dead-space” volumes at the sensor element 114. In the humidity sensor 100 construction of FIG. 5A, the “dead-space” volume 142 can be insubstantial to the performance response of the humidity sensor. And, in the case of the exemplary humidity sensor constructions 200, 300 of FIGS. 5B and 5C, the “dead-space” volume 242, 342 can be reduced to substantially zero. Similarly, in the humidity sensor constructions 400, 500 of FIGS. 6 and 7, the “dead-space” volumes are also substantially zero. As such, the humidity sensors 100, 200, 300, 400, 500 can become more reliable. Moreover, when multiple filters are employed in the humidity sensor, as described above, multiple effective “dead-space” volumes can be created in the humidity sensor to improve the barrier to moisture and particulates, etc. at the sensor element and to optimize the humidity sensor's response characteristics.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

What is claimed is:

1. A humidity sensor comprising:
a body assembly comprising an aperture;
an electronics assembly encased in the body assembly, the electronics assembly comprising a sensor element that remains exposed to the ambient environment through the aperture in the body assembly; and
a filter comprising a porous membrane covering the aperture;
wherein the filter is located directly adjacent to the sensor element such that a dead space volume of the humidity sensor is substantially eliminated.

2. The humidity sensor of claim 1 wherein the filter covers a first end of the aperture; and
further comprising a second filter comprising a porous membrane covering a second end of the aperture, wherein the second filter is located on an exterior surface of the body.

3. The humidity sensor of claim 1 wherein the electronics assembly is substantially encapsulated by a plastic material comprising a locating detent;
wherein the body assembly further comprises a locating projection; and
wherein the locating detent and the locating projection cooperate to position the electronics assembly within the body assembly.

4. A humidity sensor comprising:
a body comprising an aperture;
an electronics assembly encased in the body, the electronics assembly comprising a sensor element that remains exposed to the ambient environment of the humidity sensor through the aperture in the body;
a first filter covering the aperture, wherein the first filter is located directly adjacent to the sensor element; and
a second filter covering the aperture, wherein the second filter is located on an exterior surface of the body.

5. The humidity sensor of claim 4 wherein the electronics assembly is substantially encapsulated by a plastic material comprising a locating detent;
wherein the body further comprises a locating projection; and
wherein the locating projection is received in the locating detent.

6. A humidity sensor comprising:
a body comprising an aperture;
a first molded sub-assembly at least partially encapsulating an electronics assembly and a filter, the electronics assembly including a sensor element, and wherein the filter is disposed directly adjacent to the sensor element;
the first molded sub-assembly being fixed within the body such that the filter and sensor element are aligned with the aperture in the body and are exposed to the ambient environment of the humidity sensor through the aperture in the body.

7. The humidity sensor of claim 6, further comprising a second filter covering the aperture, wherein the second filter is located on an exterior surface of the body.

8. The humidity sensor of claim 6 wherein the first molded sub-assembly comprises a locating detent in an exterior surface thereof;
wherein the body further comprises a locating projection on an interior surface thereof; and
wherein the locating projection is received within the locating detent.

9. A humidity sensor comprising:
a body comprising an aperture;
an electronics assembly comprising a sensor element disposed on a printed circuit board substrate;
a filter directly adjacent to and covering the sensor element;
wherein the electronics assembly and the filter are encased within the body, the sensor element remaining exposed to the ambient environment by way of the aperture in the body.

10. The humidity sensor of claim 9 wherein the body further comprises at least one channel in an exterior surface of the body extending outwardly from the aperture.

11. The humidity sensor of claim 10 wherein the at least one channel is pitched in a direction away from the aperture.

12. The humidity sensor of claim 9 further comprising a housing comprising a positioning feature for locating the electronics assembly relative to the housing.

13. The humidity sensor of claim 12 wherein the housing further comprises a retaining feature for holding the electronics assembly in place in the housing prior to encasing the electronic assembly within the body.
